(19) United States
(12) Patent Application Publication
(10) Pub. No.: US 2025/0342759 A1
(43) Pub. Date: Nov. 6, 2025

(54) SYSTEM AND METHOD FOR DETECTING THREAT EVENTS AND GENERATING RESPONSES AND METRICS AUTONOMOUSLY

(71) Applicant: Gnanavel Shanmugam, San Jose, CA (US)

(72) Inventor: Gnanavel Shanmugam, San Jose, CA (US)

(21) Appl. No.: 18/654,120

(22) Filed: May 3, 2024

(51) Int. Cl. G08B 21/02; G06F 40/40; G06V 20/40; G06V 20/52; G06V 40/10; G08B 25/00

(52) U.S. Cl. CPC G08B 21/02; G06F 40/40; G06V 20/44; G06V 20/52; G06V 40/10; G08B 25/00

(57) ABSTRACT

A method includes providing a camera proximate a safety zone, wherein the camera is configured to detect a threat event in the safety zone, providing a computing device configured to generate a safety response based on threat event information, detecting, by the camera, a first threat event, generating, by the camera, a first set of threat event information based on the first threat event, receiving, by the computing device, the first set of threat event information, generating, by the computing device, a first safety response based on the first set of threat event information, and initiating the first safety response.

### BACKGROUND

Public threat events involving weapons being brandished and ultimately being used on unsuspecting people are on the rise. Concurrently, the use of security cameras to monitor areas is also on the rise. There is a need to leverage the use of security cameras to detect threat events involving weapons and expeditiously remediate the threat event via an autonomous safety response. In addition, there is a need for increased awareness of relative safety levels of an area to reduce or avoid altogether casualties resulting from crowded areas that involve a threat event.

### SUMMARY

In accordance with the present disclosure, one or more systems and/or methods are provided. In an example, in connection with an autonomous threat detection and safety response system, a camera is provided proximate a safety zone. The camera is configured to detect a threat event in the safety zone. A computing device is provided that is configured to generate a safety response based on threat event information. The camera detects a first threat event and generates a first set of threat event information based on the first threat event. The computing device receives the first set of threat event information and generates a first safety response based on the first set of threat event information, and initiates the first safety response. In some embodiments, the safety response comprises a safety alert. In some embodiments, the safety alert may carry insights (e.g., natural language insights, relevant images or audio clips) generated by at least one multimodal model.

In another example, in connection with an autonomous threat and safety context factor detection and safety response system, a camera is provided proximate a safety zone. The camera is configured to detect a threat event and a safety context factor in the safety zone. A computing device is provided that is configured to generate a safety response based on threat event information and safety context factor information. The camera detects a first threat event and a first safety context factor and generates a first set of threat event information based on the first threat event and a first set of safety context factor information based on the first safety context factor. The computing device receives the first set of threat event information and first set of safety context factor information and generates a first safety response based thereon, and initiates the first safety response. In some embodiments, the safety response comprises a safety alert. In some embodiments, the safety alert may carry insights (e.g., natural language insights, relevant images or audio clips) generated by at least one multimodal model.

In another example, in connection with an autonomous safety context factor detection and safety metric generation system, a camera is provided proximate a safety zone. The camera is configured to detect a safety context factor in the safety zone. A computing device is provided that is configured to generate a safety metric based on safety context factor update information. A client device is provided that is configured to receive and display a safety metric. The camera detects a first safety context factor and generates a first set of safety context factor update information based on the first safety context factor. The computing device receives the first set of safety context factor update information and generates a first safety metric based thereon, and communicates the first safety metric to the client device, which displays the first safety metric. In some embodiments, the safety metric may comprise an insight (e.g., natural language insight, relevant image or audio clips) generated by at least one multimodal model.

### DESCRIPTION OF THE DRAWINGS

While the techniques presented herein may be embodied in alternative forms, the particular embodiments illustrated in the drawings are only a few examples that are supplemental of the description provided herein. These embodiments are not to be interpreted in a limiting manner, such as limiting the claims appended hereto.

FIG. 1 is a flow chart illustrating an example method for autonomously detecting threat events and generating a safety response, in accordance with one or more embodiments set forth herein.

FIG. 2 is a schematic drawing illustrating portions of a system useful for autonomously detecting threat events and safety context factors and generating safety responses and safety metrics, in accordance with one or more embodiments set forth herein.

FIG. 3A shows a line drawing illustrating an exemplary image of a scene including a bounding box applied to a human, in accordance with one or more embodiments as set forth herein.

FIG. 3B shows a line drawing illustrating an exemplary image of the scene of FIG. 3A, at a later time, including a bounding box applied to a human, in accordance with one or more embodiments as set forth herein.

FIG. 4 is a flow chart illustrating an example method for autonomously detecting threat events and safety context factors and generating a safety response, in accordance with one or more embodiments set forth herein.

FIG. 5 is a component block diagram illustrating an example system for autonomously providing safety metrics, in accordance with one or more embodiments set forth herein.

FIG. 6 is a flow chart illustrating an example method for autonomously detecting safety context factors and generating safety metrics, in accordance with one or more embodiments set forth herein.

FIG. 7A is a component block diagram showing a high-level logical arrangement of certain components for an exemplary computer system which may be employed to practice one or more embodiments set forth herein, or portions thereof.

FIG. 7B is a component block diagram showing a more granular logical arrangement of certain components demonstrating an architecture for an exemplary computer system which may be employed to practice one or more embodiments set forth herein, or portions thereof.

FIG. 8 is an illustration of a scenario featuring an example non-transitory machine-readable medium in accordance with one or more embodiments set forth herein.

### DETAILED DESCRIPTION

Subject matter will now be described more fully hereinafter with reference to the accompanying drawings, which form a part hereof, and which show, by way of illustration, specific example embodiments. This description is not intended as an extensive or detailed discussion of known concepts. Details that are known generally to those of ordinary skill in the relevant art may have been omitted, or may be handled in summary fashion.

The following subject matter may be embodied in a variety of different forms, such as methods, devices, components, and/or systems. Accordingly, this subject matter is not intended to be construed as limited to any example embodiments set forth herein. Rather, example embodiments are provided merely to be illustrative. Such embodiments may, for example, take the form of hardware, software, firmware or any combination thereof.

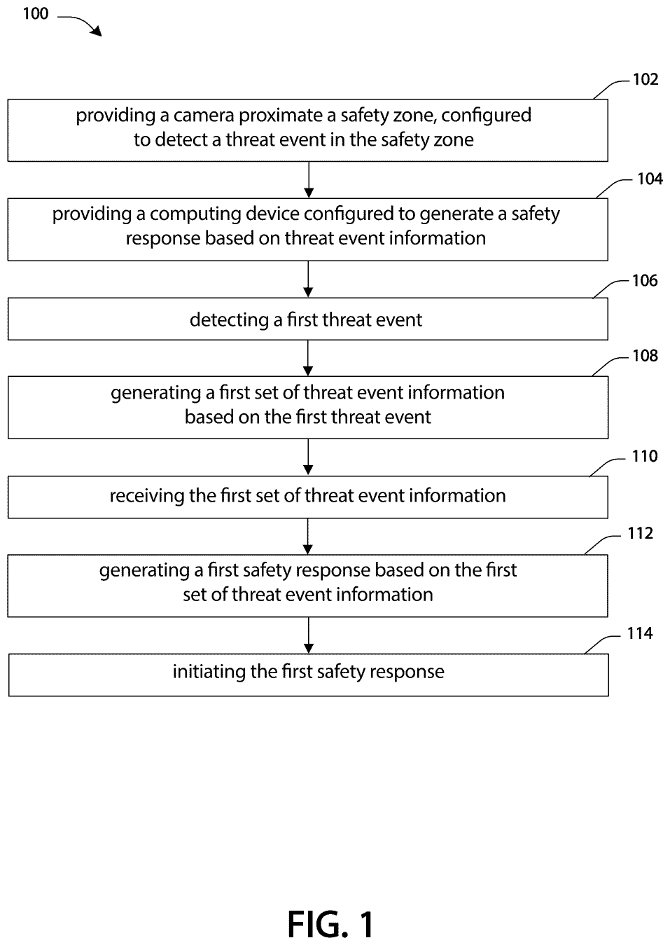

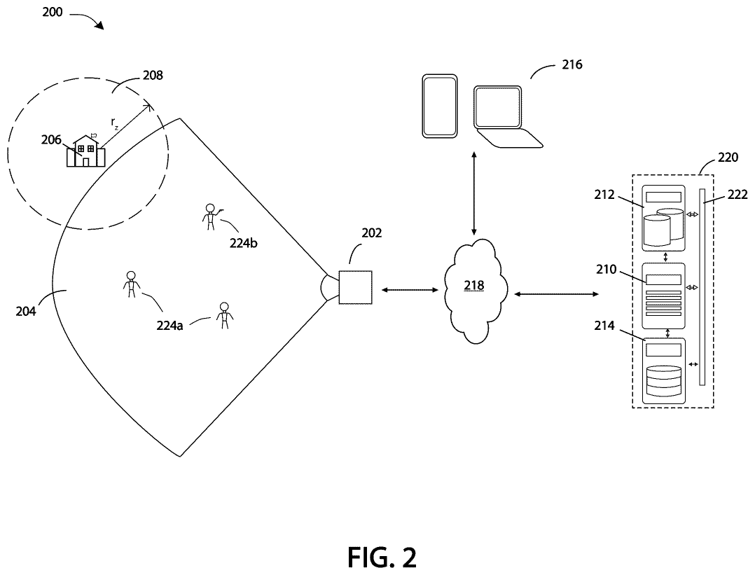

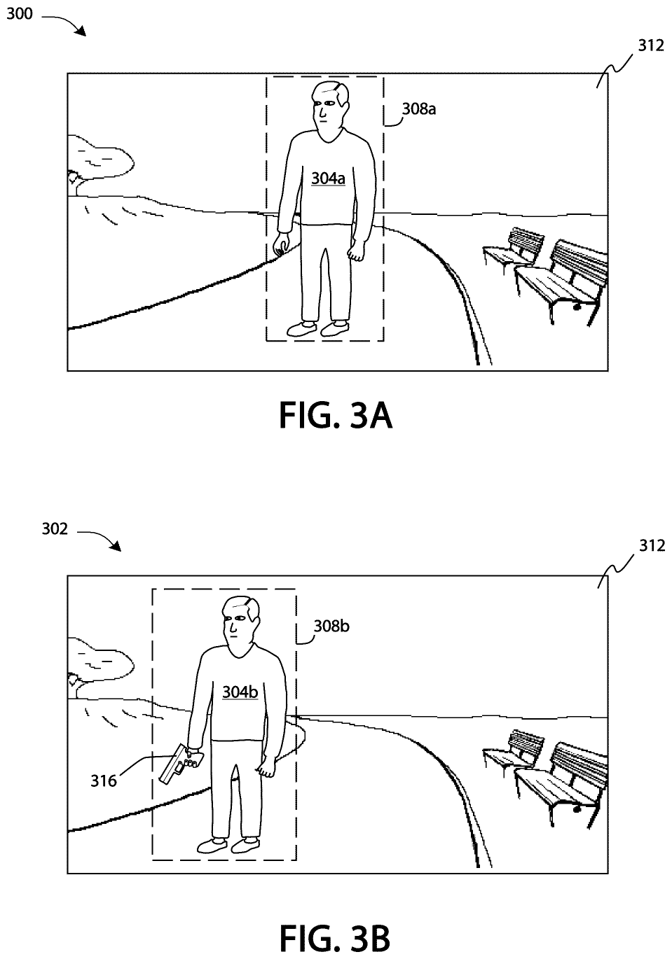

An embodiment of systems and methods for autonomously detecting threats events and generating safety responses is illustrated by example method 100 of FIG. 1, and is further described in conjunction with threat detection system 200, portions of which are illustrated in FIGS. 2 and 3. In some examples, the threat detection system may comprise a camera device, such as security camera 202 in FIG. 2. Note that, unless context dictates otherwise, the terms “camera”, camera device,” and “video device” are used interchangeably herein to refer to generally any image or video capture device sufficient to provide the functionality described herein.

In general, a camera of the present embodiments (e.g., camera 202) has an associated field of view, and such field of view characterizes a monitored area, such as monitored area/safety zone 204 of device 202. In general, one or more exemplary embodiments of the methods and systems of the present disclosure may be utilized in one or more monitored areas associated with one or more cameras, such as monitored area 204 and device 202. For example, in some embodiments, more than one camera may be deployed in one or more additional locations, including interior spaces (buildings), than that illustrated in FIG. 2. Note that, unless context dictates otherwise, the terms “monitored area” and “safety zone” are used interchangeably herein.

In some embodiments, one or more locations of interest (LOIs) may be located within or proximate to a safety zone. For example, in the embodiment illustrated in FIG. 2, LOI 206 is a school that lies proximate to monitored area 204. In general, an LOI's proximity status (i.e., proximity or lack of proximity) to a safety zone (e.g. area 204) may be determined in any manner sufficient to provide the functionality disclosed herein. For example, proximity status may be determined by calculating an LOI zone (area) of predefined dimensions, such as a circular area of a characteristic radius, r_{z}, centered on the LOI, and classifying as proximate the LOI if any portion of the zone is located within the monitored area. For example, in FIG. 2, LOI 206 may be considered proximate monitored area 204 since a portion of circular zone 208 (centered on LOI 206) is located within monitored area 204. Although the exemplary embodiment of FIG. 2 utilizes a circular area centered on an LOI to determine proximity status, it may be appreciated that other zone configurations located on an LOI (e.g., ad hoc areas, rectangular areas, etc.) may be utilized in the embodiments herein.

With continuing reference to FIG. 2, system 200 may include one or more application servers 210 and one or more application databases 214 and/or one or more application storages 212. In some embodiments, system 200 may include one or more personal computing or client devices 216. In one or more embodiments, client device(s) 216, application server(s) 210, storage 212, database(s) 214 and/or camera device(s) 202 may be communicatively coupled via one or more network(s) 218. Network(s) 218 may comprise the internet, intranets, extranets, local area networks (LANs), wide area networks (WANs), wired networks, wireless network (using wireless protocols and technologies such as, e.g., Wifi or cellular), or any other network suitable for providing data communications between two machines, environments, devices, networks, etc. In one or more embodiments, application server 210, database 214 and/or storage 212 may be implemented on networked dedicated host machines; in other embodiments, they may be hosted as services in one or more service provider environments 220. In general, a service provider environment, such as service provider environment 220, may comprise cloud infrastructure, platform, and/or software providing various servers, databases, data stores, and the like.

Application server 210, database 214, and/or storage 212 may host threat management software 222. In general, threat management software 222 may comprise one or more software applications, programs, components, code portions, scripts, or modules, stores, and the like, that are generally configured to provide backend functionality, server to client functionality, and/or web application functionality, to one or more additional software applications, programs, components, code portions, scripts, stores or modules, and the like (not shown), running on one or more devices (e.g., camera device 202). For example, in some exemplary embodiments, the aforementioned one or more additional software applications, programs, components, etc. may be configured to provide one or more trained models (not shown), such as computer vision models or multimodal models trained to detect certain objects and/or features, such as certain threat events and safety context factors, or component thereof, as further described below. Note that, unless context dictates otherwise, such additional software may be referenced collectively and interchangeably herein as model(s), model software, trained models, etc.

With reference to FIGS. 3A & 3B, a camera device in one or more of the systems and methods disclosed herein (e.g., camera 202) may be configured detect one or more threat events, such as the threat event illustrated by FIG. 3B (e.g., brandishing a handgun). FIGS. 3A & 3B depict two example images (video frames) 300, 302 obtained by a camera device (e.g., camera 202). As illustrated, in one or more embodiments, camera 202 may detect objects, such as a person (person 304a,b) using, for example, bounding boxes (e.g., boxes 308a,b) to roughly (e.g., semantically) classify/differentiate objects of interest (e.g., humans) from background and/or environment, such as environment 312. In one or more embodiments, the camera (e.g., camera 202) may also be trained to provide feature-driven detection of objects (humans) capable of determining when a person is brandishing a weapon, such as handgun 316. In some embodiments, the camera may be trained to detect other weapons, such as, e.g., rifles, shotguns, swords, knives, clubs, etc.

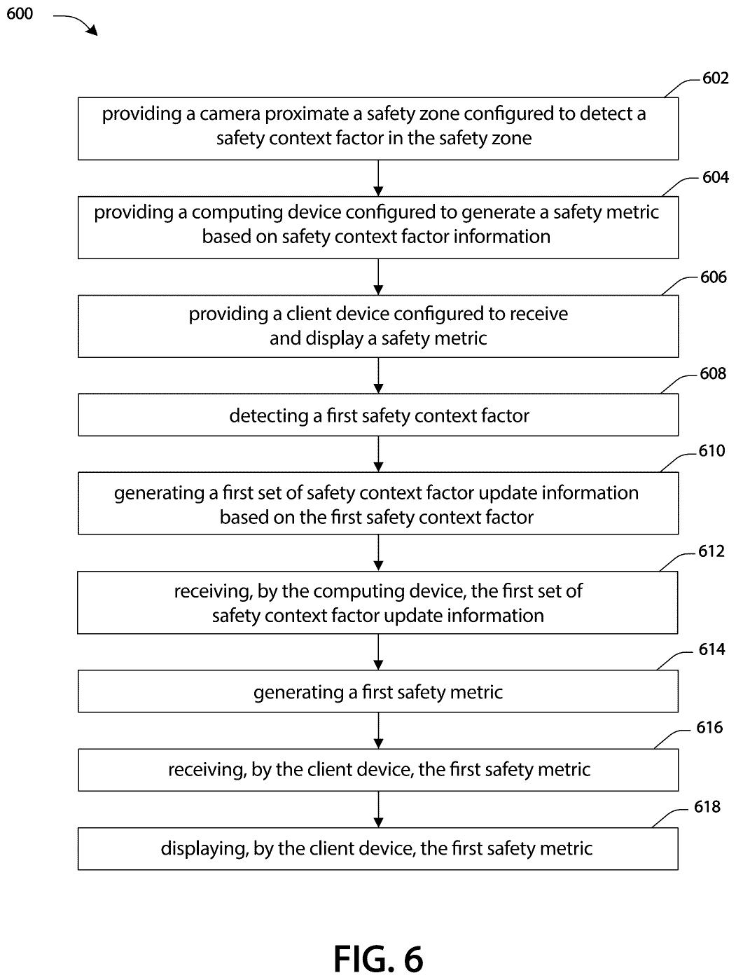

Camera devices in one or more of the embodiments herein may comprise one or more visions processors, GPUs, and/or CPUs (not shown) and associated memory, caches, storages and/or non-transitory computer-readable medium configured to run computer vision software, firmware and/or hardware sufficient to provide the functionality disclosed herein. Relatedly and/or additionally, each camera may be configured to run one or more trained object detection models and/or to be tightly linked with another device (e.g., a local processing or edge device linked with the camera, hereinafter referenced as local device) over one or more networks using one or more communication protocols. Note that, unless context dictates otherwise, the term “camera” as used herein refers both to a camera device that is configured to run the one or more object detection models referenced herein, as well as cameras that are not configured to run those models, but that are linked to another device (local device) that is configured to run the one or more object detection models referenced herein. Additional description of the processing devices utilized in the embodiments disclosed herein is detailed below in relation to FIG. 6.

In general, the cameras and any related devices (e.g., linked local edge processing devices, if any) of the embodiments disclosed herein may have any architecture and be configured in any manner sufficient to provide the functionality disclosed herein, including being configured to perform image processing and run one or more trained models for computer vision and feature recognition. For example, one or more trained models (e.g., convolutional neural networks), algorithms, scripts, programs, code, components, etc., pipelined or organized in any suitable manner, may provide the image processing, image localization, object recognition and segmentation, feature and attribute recognition, etc., sufficient to provide the functionality disclosed herein. Similarly, model training may be performed in generally any suitable manner sufficient to provide the functionality disclosed herein. For example, in some embodiments, model training software may be hosted on one or more devices or environments (e.g., application server 210, environment 220) communicatively coupled to the one or more cameras, and used to add, revise, update model parameters on the one or more cameras after training on new data and data sets, as the case may be.

With reference to FIG. 1, a method 100 of detecting and responding to a threat event autonomously is detailed, according to one or more embodiments disclosed herein. At 102, a camera (camera 202) may be provided proximate a safety zone (safety zone 204), wherein the camera is configured to detect a threat event in the safety zone. In some embodiments, the threat event may comprise a person holding a brandished weapon. For example, in some embodiments, the weapon may comprise a gun (e.g., handgun 316), a knife, and/or a club. In some embodiments, the threat event may comprise a person carrying a weapon in a concealed manner, such as, e.g., a handgun in a shoulder holster.

At 104 a computing device (e.g., application server 210) may be provided, wherein the computing device is configured to generate a safety response based on threat event information. For example, in one or more embodiments, server 210 may run an instance of threat management software 222 that is configured to generate a safety response upon receiving threat event information from a camera device (e.g., camera 202). In general, in the embodiments disclosed herein, threat event information may comprise any information that characterizes a threat event sufficiently to provide the functionality disclosed herein, as further described below in relation to 108.

At 106, a first threat event may be detected by a camera device (e.g., camera 202). In one or more embodiments, the camera may analyze each frame of its video stream or sample frames of its video stream at regular intervals, for example (in either case, each frame being referenced herein as an image). In some embodiments, the camera may, for each image, locate and classify humans from other objects and from the environment. In some embodiments, the camera may, for each image and/or for each human object, seek to detect a human with a weapon by, for example, using bounding boxes (e.g., bounding boxes 308 in FIG. 3) to focus one or more feature and/or attribute extraction models (e.g., convolutional neural network models) to detect a weapon feature. In some embodiments, the model may be trained to detect a brandished weapon and/or a concealed weapon. For example, in FIG. 2 each human 224 in safety zone 204 may be identified and analyzed by a camera device (e.g., camera 202) for a threat event (e.g., brandished and/or concealed weapon), as with human 224b. In some embodiments, the weapon may be a gun, a knife, and/or a club.

At 108, a first set of threat event information may be generated by the camera (e.g., camera 202), based on the first threat event. In general, in one or more embodiments, the camera devices may be configured to store in a non-transitory computer readable medium (e.g., memory, data store, stored data structure, file system, etc.) at least a portion of the output generated by the one or models upon analyzing an image or images depicting or otherwise showing a threat event, and such stored output may generally be referred to as a set of threat event information as used herein. The first set of threat event information may generally be considered to be the first of such sets, and may generally correlate with the first or one of the first images to have depicted or otherwise shown a threat event with respect to a given threat event (i.e., multiple threat events may each have a corresponding first set of threat event information associated with it). In some embodiments, the camera may be configured to store all or a portion of the model output for the entire image depicting the threat event and/or just the portion of the image corresponding to the relevant detected object (e.g., human 224b, 308b), such as, for example, classification and feature extraction/detection model output(s) for the relevant bounding box. In some embodiments, threat event information may comprise the image or relevant portion of the image (e.g. bounding box) depicting the threat event, classification information (e.g., class type (human, male, etc.)), geolocation information (e.g., latitude and longitude), timestamp, and/or feature (e.g., weapon type) classification information, etc. In some embodiments, threat event information may comprise the image or relevant portion of the image depicting the threat event, an indicator of event type (e.g., gun brandishing, knife brandishing, club brandishing, gun concealed-carry, etc.), geolocation information (e.g., latitude and longitude), and/or timestamp, etc.

At 110, the first set of threat event information may be received by the computing device (e.g., computing device 210). In general, as described above in relation to 104, computing device 210 may be configured to generate a safety response based on threat event information. in one or more embodiments, the stored set(s) of threat event information may be published to, sent to, accessed by and/or retrieved by computing device 210. In particular, the first set of threat event information may be sent to a linked component, application, device, etc., such as, for example, an instance of threat management software 222 running on computing device 210.

At 112, a first safety response based on the first set of threat event information may be generated by the computing device (e.g., computing device 210). In some embodiments, the first safety response may be generated by threat management software 222 running on device 210 upon receiving the first set of threat event information. In general, a safety response may comprise generally any suitable action or set of actions tending to alleviate or otherwise address the relevant threat event, sufficient to provide the functionality described herein. For example, in some embodiments, computing device 210 may be configured to generate a first safety alert upon receiving the first set of threat event information.

A safety alert of the systems and methods disclosed herein may generally comprise any suitable message and data, configured in generally any suitable manner, sufficient to provide the functionality described herein. In some embodiments, a safety alert may comprise an alert message sent to a pre-configured recipient (address), using generally any communication protocol, and containing a data payload comprising at least a portion of the received set of threat event information (e.g., first set of threat event information). For example, in some embodiments, the payload may comprise the relevant image or image portion (e.g. identifying the threat event), the event type (e.g., indication of gun brandished, knife brandished, concealed gun detection, etc.), location information (address, camera identifier, and/or geolocation coordinates, etc.), and/or timestamp information. In some embodiments, the computing device may be configured to associate predetermined alert recipient information (e.g., recipient IP address(es)) with each camera device, such that upon receiving a set of threat event information from a given camera device (e.g., camera 202), the computing device (e.g. computing device 210) may generate a safety alert that is addressed using the pre-configured recipient information associated with that camera. In some embodiments, the recipient address information may be determined by computing device 210 based on a portion of the received set of threat event information (e.g., camera location information). In some embodiments, upon receiving a set of threat event information (e.g., a first set), the computing device may generate a safety alert addressed to a local law enforcement device (e.g., police department computing system), a local private security computing system, a local business computing system or local LOI, local personal devices, and/or a local media outlet. A person of ordinary skill may understand that a “local” recipient is a recipient local to the relevant camera device.

In some embodiments, the computing device (e.g., computing device 210) may be configured to generate additional safety response information based on the received set of threat event information. In some embodiments, the additional safety response information may be included in the generated safety alert(s) (e.g., as part of the safety alert payload). For example, in some embodiments, the computing device may generate personal identifying information (e.g., name, date of birth, social security number, residence information, and/or demographic information, etc.) of the human detected as the threat event from public or private data sources or services. For example, in some embodiments, the computing device may use location and timestamp information of the received threat event information to obtain personal identifying information from a service based on cellular or wifi device records, and the like.

In some embodiments, the computing device (e.g., computing device 210) may be configured to generate additional safety response action based on the received set of threat event information. In some embodiments, the additional action may be provided to one or more interested users via API, publication, connected user interface, etc. For example, in one or more embodiments, the computing device may be configured to generate an evacuation route away from the threat event, as via a map or breadcrumb user interface.

In some embodiments, the computing device (e.g., computing device 210) may be configured to generate one or more insights, such as for example, natural language (NL) safety response insight(s) from one or more large language models (LLMs), image, video and/or audio clip insights from one or more multimodal models (e.g., multimodal transformer models), based on the received set of threat event information, and to include the safety response insight(s) in the generated safety alert (e.g., first safety alert, as part of the safety alert payload) and/or to provide the insight to one or more interested users via API, publication, connected user interface, etc. For example, in one or more embodiments, computing device 210 may be configured to run one or more agents or assistants to interface with one or more LLMs by prompting the one or more LLMs to provide NL insight on at least a portion of the received threat event information (e.g., the first set of threat event information), and to receive any returned NL insight and include the NL insight(s) in the safety alert (e.g., as part of the safety alert payload) and/or to provide the NL insight to one or more interested users via API, publication, connected user interface, etc. In some embodiments, the one or more LLMs may comprise one or more LLM services provided by Anthropic (e.g., Claude 2), Amazon (e.g., Titan), Meta (Llama 2), Cohere (e.g., Command), AI21 Labs (e.g., Jurassic), etc.

At 114, the first safety response may be initiated by the computing device (e.g., computing device 210). In one or more embodiments, upon generating the first safety response, the computing device may initiate the first safety response by executing the action (e.g. safety alert) or first action of a set of actions (e.g., first safety alert) comprising the first safety response. For example, in some embodiments the first safety response may comprise a safety alert, and computing device 210 may initiate the first safety response by sending the safety alert to the addressed recipient(s).

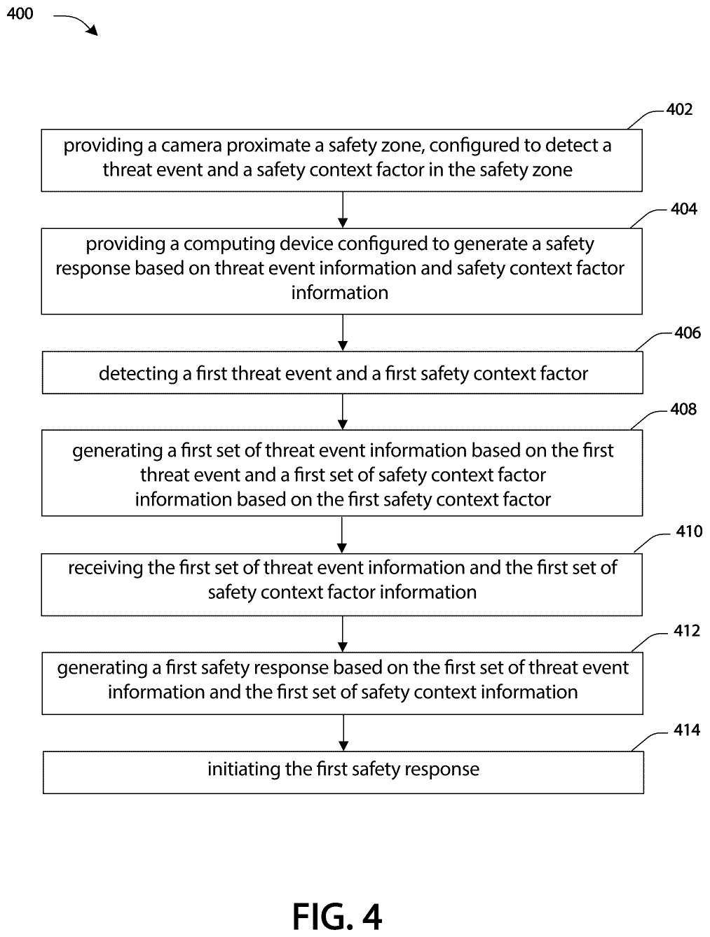

With reference now to FIG. 4, a method 400 of autonomously detecting threats events and generating safety responses is detailed, according to one or more embodiments disclosed herein. At 402, a camera (e.g., camera 202) may be provided proximate a safety zone (safety zone 204), wherein the camera is configured to detect a threat event in the safety zone and a safety context factor in the safety zone. In some embodiments, the threat event may comprise a person holding a brandished weapon. For example, in some embodiments, the weapon may comprise a gun (e.g., handgun 316), a knife, and/or a club. In some embodiments, the threat event may comprise a person carrying a weapon in a concealed manner, such as, e.g., a handgun in a shoulder holster.

Safety context factors may comprise generally any safety-related factors that are not a threat event, that are detectable by one or more computer vision devices and/or models, sufficient to provide the functionality disclosed herein. For example, in some embodiments, safety context factors may comprise the number of people in a safety zone at a given time, demographic-related factors (e.g., number of males in safety zone at a given time, number of males above certain age in a safety zone at a given time), personally identifying factors (e.g., identity of one or more persons detected in safety zone at a given time), concealed weapon indicators, and/or other safety-related features of the objects detected in a safety zone (e.g., type of clothing detected on a person in a safety zone (e.g., swimwear, summer-wear, baggy clothing, jeans, etc.)).

At 404, a computing device (e.g., application server 210) may be provided, wherein the computing device is configured to generate a safety response based on threat event information and safety context factor information. For example, in one or more embodiments, server 210 may run an instance of threat management software 222 that is configured to generate a safety response upon receiving threat event information and safety context factor information from a camera device (e.g., camera 202). In general, in the embodiments disclosed herein, threat event information may comprise any information that characterizes a threat event sufficiently to provide the functionality disclosed herein, as further described below in relation to 408. In general, in the embodiments disclosed herein, safety context factor information may comprise at least one safety context factor detected by the relevant camera at the time of the threat event in question, as further described below in relation to 408.

At 406, a first threat event and a first safety context factor may be detected by a camera (e.g., camera 202). In one or more embodiments, the camera may analyze each frame of its video stream or sample frames of its video stream at regular intervals, for example (in either case, a frame being referenced herein as an image). In some embodiments, the camera may, for each image, locate and classify humans from other objects and from the environment. In some embodiments, the camera may, for each image and/or for each human object, seek to detect a human with a weapon by, for example, using bounding boxes (e.g., bounding boxes 308 in FIG. 3) to focus one or more feature and/or attribute extraction models (e.g., convolutional neural network models) to detect a weapon feature. In some embodiments, the model may be trained to detect a brandished weapon and/or a concealed weapon. For example, in FIG. 2 each human 224 in safety zone 204 may be detected as human and analyzed by a camera device (e.g., camera 202) for a threat event (e.g., brandished and/or concealed weapon), as with human 224b. In some embodiments, the weapon may be a gun, a knife, and/or a club. Unless context dictates otherwise, the aforementioned models may be referred to herein as threat event models.

Similarly, in some embodiments, the camera may, for each image and/or for each detected human, seek to identify one or more safety context factors by, for example, using bounding boxes (e.g., bounding boxes 308 in FIG. 3) to focus one or more feature and/or attribute extraction models (e.g., convolutional neural network models) to detect one or more features comprising safety context factors. In general, any suitable architecture for accomplishing the detection of one or more safety context factors may be utilized in the embodiments disclosed herein. For example, in some embodiments, the camera may be configured to identify and track each human currently present in the safety zone so as to provide model input for certain safety context factors (e.g. count of humans present in a safety zone). For example, in some embodiments, the model may be trained to detect, for each human detected in the safety zone (e.g., humans 224 in zone 204 of FIG. 2) the safety-related information described above in relation to 402, including but not limited to: demographic-related information (e.g., gender, age), personally identifying information (e.g., name, identification information), concealed weapon indicators, type of clothing detected (e.g., swimwear, summer-wear, baggy clothing, jeans), etc. In some embodiments, the camera may be configured to detect one or more safety context factors only upon detection of a threat event, rather than by tracking humans and compiling safety context factors keyed to each human. Unless context dictates otherwise, the aforementioned models may be referred to herein as safety context factor models.

At 408, a first set of threat event information may be generated by the camera (e.g., camera 202) based on the first threat event and a first set of safety context factor information may be generated by the camera based on the first safety context factor. In general, in one or more embodiments, the camera devices may be configured to store in a non-transitory computer readable medium (e.g., memory, data store, stored data structure, file system, etc.) at least a portion of the output generated by the one or more threat event models upon analyzing an image or images depicting or otherwise showing a threat event, and such stored output may generally be referred to as a set of threat event information as used herein. In some embodiments, the camera may be configured to store all or a portion of the threat event model output for the entire image depicting the threat event and/or just the portion of the image corresponding to the relevant detected object (e.g., human 224b, 308b), such as, for example, classification and feature extraction/detection threat event model output(s) for the relevant bounding box. In some embodiments, threat event information may comprise the image or relevant portion of the image depicting the threat event, an indicator of event type (e.g., gun brandishing, knife brandishing, club brandishing, gun concealed-carry, etc.), geolocation information (e.g. latitude and longitude), and/or timestamp, etc. The first set of threat event information may generally be considered to be the first of such sets, and may generally correlate with the first or one of the first images to have depicted or otherwise shown a threat event with respect to a given threat event (i.e., each threat event may have multiple subsequent sets of threat event information, and multiple threat events may each have a corresponding first set of threat event information associated with it).

Similarly, in one or more embodiments, the camera devices may be configured to store in a non-transitory computer readable medium (e.g., memory, data store, stored data structure, file system, etc.) at least a portion of the output generated by the one or more safety context factor models upon analyzing an image or images depicting or otherwise showing a threat event, and such stored output may generally be referred to as a set of safety context factor information as used herein. In some embodiments, the camera may be configured to store all or a portion of the safety context factor model output for the entire image depicting the threat event and/or just the portion of the image corresponding to the relevant detected object (e.g., human 224b, 308b), such as, for example, classification and feature extraction/detection safety context factor model output(s) for the relevant bounding box. In some embodiments, safety context factor information may comprise the image or relevant portion of the image depicting the safety context factor, an indicator of safety context factor type (e.g., related threat event type), demographic-related information (e.g., gender, age), personally identifying information (e.g., name, identification information), concealed weapon indicators (e.g., a shoulder holster), type of clothing detected (e.g., swimwear, summer-wear, baggy clothing, jeans), etc. The first set of safety context factor information may generally be considered to be the first of such sets, and may generally correlate with the first or one of the first images to have depicted or otherwise shown a threat event with respect to a given threat event (i.e., each threat event may have multiple subsequent sets of safety context factor information, and multiple threat events may each have a corresponding first set of safety context factor information associated with it).

At 410, the first set of threat event information and the first set of safety context factor information may be received by the computing device (e.g., computing device 210). In general, as described above in relation to 404, computing device 210 may be configured to generate a safety response based on threat event information and safety context factor information. in one or more embodiments, the stored set(s) of threat event information and safety context factor information may be published to, sent to, accessed by and/or retrieved by computing device 210. In particular, the first set of threat event information and safety context factor information may be sent to a linked component, application, device, etc., such as, for example, an instance of threat management software 222 running on computing device 210.

At 412, a first safety response based on the first set of threat event information and the first set of safety context factor information may be generated by the computing device (e.g., computing device 210). In some embodiments, the first safety response may be generated by threat management software 222 running on device 210 upon receiving the first set of threat event information and first set of safety context factor information. In general, a safety response may comprise generally any suitable action or set of actions tending to alleviate or otherwise address the relevant threat event, sufficient to provide the functionality described herein. For example, in some embodiments, computing device 210 may be configured to generate a first safety alert upon receiving the first set of threat event information and first set of safety context factor information. A safety alert of the systems and methods disclosed herein may generally comprise any suitable message and data, configured in generally any suitable manner, sufficient to provide the functionality described herein, and is described further in relation to 112, above.

In some embodiments, a safety alert data payload may comprise, in addition to at least a portion of the received set of threat event information, at least a portion of the received set of safety context factor information (e.g., first set of safety context factor information). For example, in some embodiments, the payload may comprise demographic-related information of the human making the threat event, or other humans in the safety zone (e.g., gender, age), personally identifying information of the human making the threat event, or other humans in the safety zone (e.g., name, identification information), number of humans in the safety zone, etc.

In some embodiments, the computing device may be configured to associate predetermined alert recipient information (e.g., recipient IP address(es)) with each camera device, such that upon receiving a set of threat event information from a given camera device (e.g., camera 202), the computing device (e.g. computing device 210) may generate a safety alert that is addressed using the pre-configured recipient information associated with that camera. In some embodiments, the recipient address information may be determined by computing device 210 based on a portion of the received set of threat event information (e.g., camera location information) and/or the received set of safety context factor information (e.g., identity of humans in the safety zone). In some embodiments, upon receiving a set of threat event and safety context factor information (e.g., a first set), the computing device may generate a safety alert addressed to a local police department, a local private security system, a local business or local LOI, local devices, and/or a local media outlet. A person of ordinary skill may understand that a “local” recipient is a recipient local to the relevant camera device.

In some embodiments, the computing device (e.g., computing device 210) may be configured to generate additional safety response information based on the received set of threat event information and/or safety context factor information. In some embodiments, the additional safety response information may be included in the generated safety alert(s) (e.g., as part of the safety alert payload). For example, in some embodiments, the computing device may generate personal identifying information (e.g., name, date of birth, social security number, residence information, and/or demographic information, etc.) of the human detected as the threat event from public or private data sources or services and/or of other humans present in the safety zone. For example, in some embodiments, the computing device may use location and timestamp information of the received threat event information to obtain personal identifying information from a service based on cellular or wifi device records, and the like.

In some embodiments, the computing device (e.g., computing device 210) may be configured to generate additional safety response action based on the received set of threat event information and/or safety context factor information. In some embodiments, the additional action may be provided to one or more interested users via API, publication, connected user interface, etc. For example, in one or more embodiments, the computing device may be configured to generate an evacuation route away from the threat event, as via a map or breadcrumb user interface.

In some embodiments, the computing device (e.g., computing device 210) may be configured to generate insights, such as for example, natural language (NL) safety response insight(s) from one or more large language models (LLMs), image, video and/or audio clip insights from one or more multimodal models (e.g., multimodal transformer models), based on the received set of threat event information and/or received set of safety context factor information, and to include the NL safety response insight(s) in the generated safety alert (e.g., first safety alert, as part of the safety alert payload) and/or to provide the insight to one or more interested users via API, publication, connected user interface, etc. For example, in one or more embodiments, computing device 210 may be configured to run one or more agents or assistants to interface with one or more LLMs by prompting the one or more LLMs to provide NL insight on at least a portion of the received threat event information and/or safety context factor information (e.g., the first set of threat event information and/or first set of safety context factor information), and to receive any returned NL insight and include the NL insight(s) in the safety alert (e.g., as part of the safety alert payload) and/or to provide the NL insight to one or more interested users via API, publication, connected user interface, etc. In some embodiments, the one or more LLMs may comprise one or more LLM services provided by Anthropic (e.g., Claude 2), Amazon (e.g., Titan), Meta (Llama 2), Cohere (e.g., Command), AI21 Labs (e.g., Jurassic), etc.

At 414, the first safety response may be initiated by the computing device (e.g., computing device 210). In one or more embodiments, upon generating the first safety response, the computing device may initiate the first safety response by executing the action (e.g. safety alert) or first action of a set of actions (e.g., first safety alert) comprising the first safety response. For example, in some embodiments the first safety response may comprise a safety alert, and computing device 210 may initiate the first safety response by sending the safety alert to the addressed recipient(s).

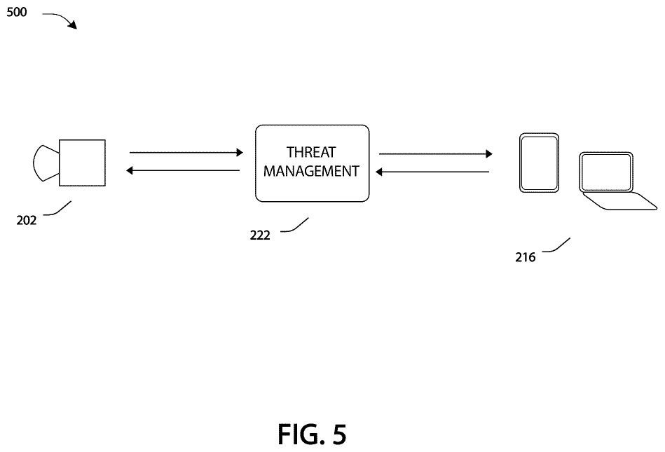

With reference now to FIG. 6, a method 600 of autonomously detecting safety context factors and generating safety metrics is detailed, according to one or more embodiments disclosed herein. Reference is also made to safety metric reporting system 500, portions of which are illustrated in FIG. 5, and to threat detection system 200, portions of which are illustrated in FIGS. 2 and 3.

At 602, a camera may be provided proximate a safety zone, wherein the camera is configured to detect a safety context factor in the safety zone. For example, in some embodiments, the camera may comprise camera 202 show in FIGS. 2 and 5, and safety zone may be safety zone 204 of FIG. 2. Safety context factors are described in detail above in relation to FIG. 4.

At 604, a computing device (e.g., application server 210) may be provided, wherein the computing device is configured to generate a safety metric based on safety context factor update information. For example, in one or more embodiments, server 210 may run an instance of threat management software 222 that is configured to generate a safety metric upon receiving safety context factor update information from a camera device (e.g., camera 202). In general, in the embodiments disclosed herein, safety context factor update information may comprise safety context factor information, as described above in relation to 408, but that may be detected at the time of a threat event or at any other time, as determined by the system configuration. For example, safety factor update information may be detected and/or determined at regular intervals, in addition to at the time of a detected threat event, by camera 202.

At 606, a client device (e.g., client device 216) may be provided, wherein the client device is configured to receive and display a safety metric. In some embodiments, the client device may be configured to provide a user interface that is communicatively coupled to threat management software 222 and configured to receive (via subscription, push feed, scheduled calls to a web API, etc.) a current safety metric associated with a camera device (e.g., camera 202). In some embodiments, the client device may be configured to receive input from a user (e.g., via a user interface) and communicate the user input to threat management software 222, which may be configured to receive user input. It should be appreciated that current safety metric associated with a camera device means a safety metric generated or determined based on safety context factor update information received from the camera device. Further description of a safety metric is detailed below, in relation to 614.

At 608, a first safety context factor may be detected by a camera (e.g., camera 202). Description of detecting a first safety context factor is detailed above, in relation to 406.

At 610, a first set of safety context factor update information may be generated by the camera (e.g., camera 202) based on the first safety context factor. Description of generating a first set of safety context factor information is detailed above, in relation to 408.

At 612, the first set of safety context factor update information may be received by the computing device (e.g., computing device 210). Description of receiving, by the computing device, the first set of safety context factor update information is detailed above, in relation to 410.

At 614, a first safety metric may be generated by the computing device (e.g., computing device 210). In some embodiments, a safety metric may comprise a current threat index for the safety zone. In general, a threat index may be determined using generally any suitable method and data sufficient to provide an indication of relative threat level. For example, in some embodiments, the threat index may be determined by scoring the current set of received safety context factor update information using a scoring method that provides relative weights to different types of safety context factors (e.g., concealed weapon indication receives a greater weight than demographic information) and combines the scores into a single index value, indicating the relative threat level.

In some embodiments, a safety metric may comprise an estimate of the number of concealed weapons currently present in the safety zone. In some embodiments, the computing device (computing device 210) may determine the estimate based on the current set of received safety context factor update information. In particular, in embodiments in which the camera (e.g., camera 202) is configured to detect concealed weapons, the computing device may simply use the sum total of concealed weapon indications as the safety metric. In other embodiments, the computing device may modify (increase or decrease) the sum total of concealed weapon indications using other received current safety context factor update information (e.g., demographic information, location information, etc.).

In some embodiments, a safety metric may comprise an insight, such as for example, a natural language insight generated by a large language model, image, video and/or audio clip insight from one or more multimodal models (e.g., multimodal transformer models). For example, in some embodiments, the computing device (e.g., computing device 210) may be configured to generate) safety metric insight(s) from one or more models (large language models (LLMs), multimodal models) based on the current received set of safety context factor update information, and to provide the insight(s) as safety metrics to one or more client devices via API, publication, etc. For example, in one or more embodiments, computing device 210 may be configured to run one or more agents or assistants to interface with one or more insight models by prompting the one or more insight models to provide insight on at least a portion of the current safety context factor update information (e.g., the first set of safety context factor update information), and to receive any returned insight and provide the insight(s) as a safety metric to one or more connected client devices via API, publication, etc. In some embodiments, the one or more insight models may comprise one or more LLM services provided by Anthropic (e.g., Claude 2), Amazon (e.g., Titan), Meta (Llama 2), Cohere (e.g., Command), AI21 Labs (e.g., Jurassic), one or more multimodal model services provided by Google (Vertix), Meta (Meta AI), etc.

At 616, the client device (e.g., device 216) may receive the first safety metric. In general, any suitable means for receiving safety metrics on the client device may be utilized in the embodiments herein. For example, in some embodiments, the client device may receive current safety metrics via scheduled API calls, subscription feed, etc.

At 618, the client device may display the first safety metric to a user. In general, any suitable manner of displaying safety metrics to a user via the client device may be utilized in the embodiments herein. For example, in some embodiments, the client device may provide a user interface that provides an indication (graphical, text-based, or otherwise) of the current safety metric, and updates the user interface indication upon receiving a safety metric via scheduled API calls, subscription feed, etc. In some embodiments, current safety metrics may be displayed via text (SMS) service, etc. In some embodiments herein, the client device may provide a user interface that receives user input (e.g., text strings) and pushes or otherwise communicates the user input to the connected computing device (e.g. computing device 210). In some embodiments, the computing device may be configured to receive user input from a client device and take further action. For example, in some embodiments, the computing device (computing device 210) may be configured to receive a user request for additional insight and prompt the one or more insight models with the user request and communicate the additional insight to the relevant client device as an additional safety metric.

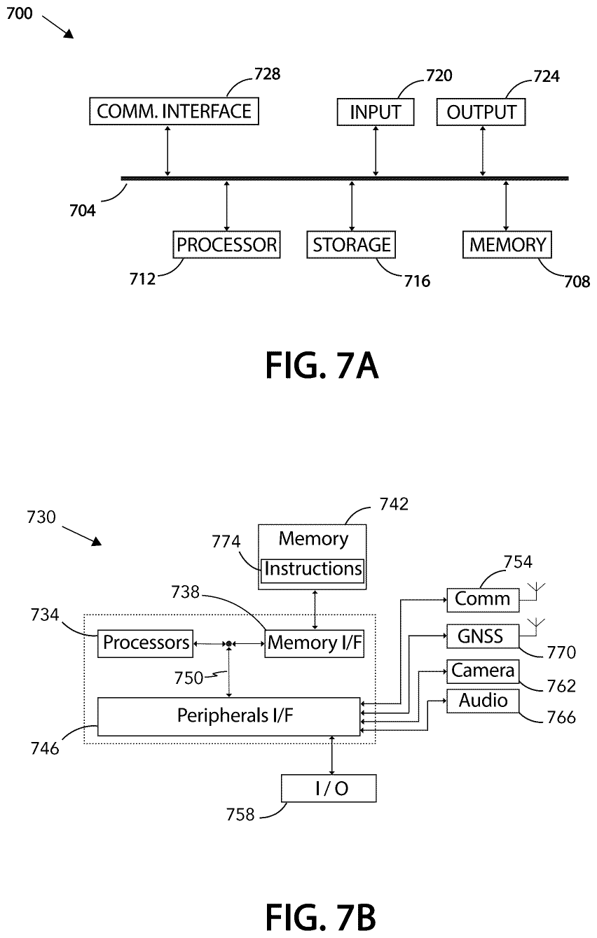

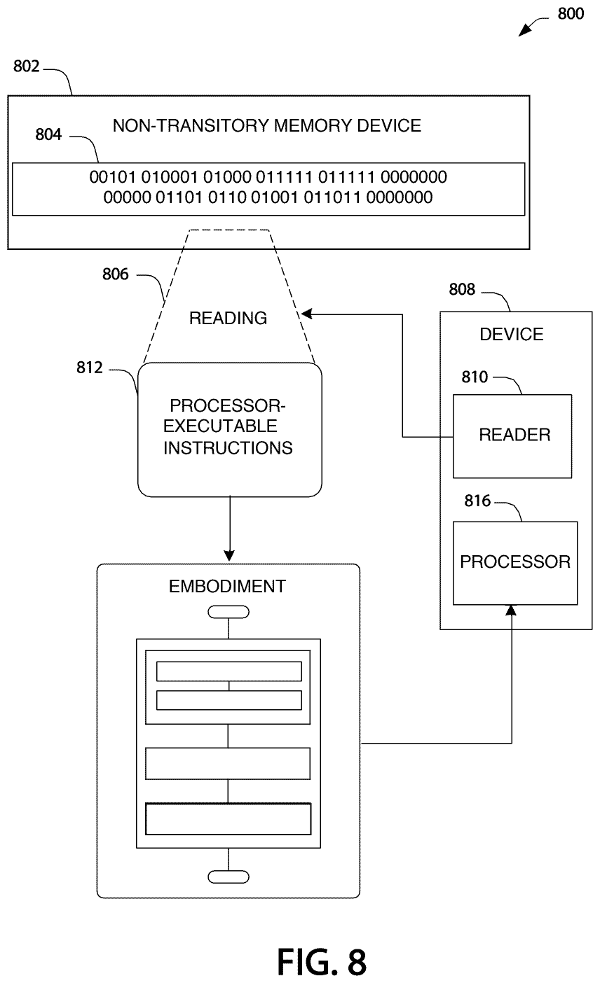

The systems and methods for autonomously detecting threats events and generating safety responses and metrics may be performed on or by one or more computer systems (one or more computing devices, alone or in combination with one or more other computing devices and/or systems), accordingly to the embodiments described herein. Generally, computer systems (such as, e.g., computing devices described in relation to systems 200, 500 may comprise any suitable machines sufficient to run one or more aspects of the systems described herein and provide the functionality described herein. For example, components of exemplary computer system 700,730 shown in FIGS. 7A & 7B may be used to implement camera 202, server 210, storage 212, database 214, and/or environment 220. In some embodiments, portions of the applications, components, modules, routines, operations, etc. described herein may be implemented on computer system 700, 730.

FIG. 7A is a block diagram showing a high-level logical arrangement of certain components for an exemplary computer system 700 which may be employed to practice embodiments or portions of embodiments of the present disclosure. Bus 704 ties system components including memory 708 (e.g., ROM and/or RAM) to processor 712. Bus 704 may generally be any suitable type of bus structure using any suitable bus architecture, such as for example, a memory bus or controller, system bus, peripheral bus, or a local bus, etc. In some embodiments, bus 704 may include specialized architectures such as shared memory for integrated GPU(s) or on-chip interconnects. Information transfer to/from the bus (and components) may be accomplished by any suitable means, such as for example a BIOS stored in ROM 708 or the like. Memory 708 may also include specialized memories such as local caches and registers. Device 700 may have more than one processor 712 or may comprise a group or cluster of computing devices 700 networked together to provide greater processing capacity. Processor 712 may include any general-purpose processor(s), such as a CPU, as well as any special-purpose processor(s), such as a vision processing unit(s) (VPU). Device 700 may include storage 716 (e.g., flash memory, hard disk drive, magnetic or optical disk drive, or the like). Storage 716 may include software, data and/or instructions for performing functions such as controlling processor 712. In general, the non-transitory computer readable storage media (memory and/or storage) provide nonvolatile storage of computer readable instructions, data structures, program modules and data for processing device 700. A person of ordinary skill in the art would know how to make variations to the basic components described to suit a particular function or need. Non-transitory computer-readable storage media expressly exclude media such as energy, carrier signals, electromagnetic waves, and signals per se.

With continuing reference to FIG. 7A, computing device 700 may comprise input devices 720 and output devices 724. In general, input devices 720 may be any number of input means, such as a digital camera or camera sub-system (e.g., e.g., CCD or CMOS-based camera sub-system), microphone for speech, a touch-sensitive screen for gesture or graphical input, a keyboard, mouse, and the like. Also in general, output devices 724 may include any number of output means, such as for example a visual monitor (touchscreen, LCD, CRT, etc.), a printer, and the like.

Communications interface(s) 728 generally governs and manages the user or system input and system output. A person of ordinary skill in the art would know how to make variations to the basic components described to suit a particular function or need, and that the basic features described here may be substituted with improved software, hardware or firmware arrangements as they are developed. Additionally and/or alternatively, communications interface 728 may generally comprise any network interface sufficient to provide the functionality described herein. For example, interface 728 may enable computing system 700 to communicate data and messages to one or more external devices in a networked environment, using generally any suitable communication protocol.

The exemplary computing system of FIG. 7A is illustrated as including individual functional blocks. In general, the functions represented by these blocks may be provided through the use of either shared or dedicated hardware, including but not limited to, hardware capable of executing software and hardware that is purpose-built to operate as an equivalent to software executing on a general-purpose processor. Some embodiments may include CPU, GPU, VPU, microprocessor and/or digital signal processor (DSP) hardware, read-only memory (ROM) for storing software performing the operations described herein, and random access memory (RAM) for storing results. Logical operations of various embodiments described herein may be implemented as, for example, a sequence of computer implemented steps, operations, or procedures running on a processor or processing resource within one or more general or specific-use computers. Device 700 may practice all or part of the recited methods, may be a part of the recited systems, and/or may operate according to instructions in the recited non-transitory computer-readable storage media. Such logical operations may be implemented as modules or components configured to control processor 712 to perform particular functions according to the programming of the module/component.

FIG. 7B is a block diagram showing a more granular logical arrangement of certain components demonstrating an architecture for an exemplary computer system 730 which may be employed to practice some embodiments or portions of some embodiments of the present disclosure. FIG. 7B and computer system 730 may be considered to be a more granular description of a subset of computer system 700 shown in FIG. 7A (e.g., security cameras), and the descriptions relating to both should be construed congruently.

Generally, system 730 may be any computer system sufficient to implement the features, functions and processes described herein in relation to FIGS. 1-6, including security cameras, CCTVs, handheld computers, mobile phones (e.g., iPhone®), laptop computers, tablet devices (e.g., iPad®), media players, personal digital assistants (PDA), server machines, desktop computers, wearable computers (e.g., Apple Watch®), or the like.

Computer system 730 may comprise one or more processors 734, a memory subsystem (e.g., interface/controller 738 and memory 742), and a peripheral subsystem (e.g., interface 746 and interfaced peripherals). The various components may be operatively associated in any suitable manner; for example, on one integrated circuit board (ICB) or multiple ICBs, via one or more hard or soft interfaces, etc. One or more buses or signal lines (e.g., bus 750) may couple the various components. A person of ordinary skill will appreciate that the architecture shown in FIG. 7B is but one exemplary architecture for computer system 730, and that computer system 730 may have more or fewer components than shown, or a different configuration of components. Components may be implemented in hardware, software, firmware, or a combination of hardware, software and firmware.

Communication subsystem 754 may comprise one or more wired or wireless communication subsystems implementing one or more communication protocols (e.g., networking protocols). Generally, in some embodiments, communication subsystem 754 may comprise one or more radio and/or infrared transmitters and receivers (or transceivers). Additionally and/or alternatively, communication subsystem 754 may comprise one or more ports (e.g., USB) for connectivity to one or more computing devices, which may themselves be wired or wireless communication devices. Generally any communication protocol and the components needed to implement the protocol via communication subsystem 754 sufficient to perform the functions described herein may be utilized in the embodiments of this disclosure. Some exemplary and non-limiting implementations include those that are configured to operate over cellular (e.g., GSM, GPRS, CDMA, EDGE) networks, IEEE802.xx communication networks (e.g., Wi-Fi, Wi-Max, ZigBee®), and/or Bluetooth® networks. In some embodiments, communication subsystem 754 may be configured to permit computer system 730 to synchronize with a host device using one or more protocols, such as, for example, TCP/IP, HTTP, UDP, ICMP, FTP, SOAP, and any other similar, suitable protocol or technology.

Referring still to FIG. 7B, computer system 730 may include peripherals such as input/output subsystem 758 (that may itself include inputs/outputs such as a touchscreen subsystem, keyboard, mouse, etc. (not shown)), camera subsystem 762, and audio subsystem 766. In one or more embodiments, computer system 730 may also comprise Global Navigation Satellite System (GNSS) subsystem 770. GNSS subsystem 770 may comprise a GNSS receiver configured to receive GNSS (e.g., GPS) satellite signals and determine and output/make available the current geolocation information (e.g., location coordinates & time) of the receiver/device on a predetermined schedule. Peripherals interface 746 may comprise a monolithic interface or multiple, specialized interfaces that themselves may comprise one or more components (hardware, software, firmware, or combinations thereof) that provide interfacing of peripheral subsystems with processors 734.

In general, memory 742 may be any suitable non-transitory machine-readable medium that can store instructions and data for use by processors 734. For example, memory 742 may comprise a high-speed random access and/or non-volatile memory including instructions configured to cause a computing device such as device 730 to perform operations and/or store data. In addition, memory 742 may comprise machine-readable storage including instructions configured to cause a computing device such as device 730 to perform operations and/or to store data. Memory 742 may comprise a memory hierarchy, including cache, main memory and secondary memory. The memory hierarchy may be implemented using any combination of RAM, ROM, FLASH, magnetic and/or optical storage devices, and the like.

In general, memory 742 may store any instructions 774 for implementing the features and processes of the embodiments disclosed herein, as described in reference to FIGS. 1-6. Some non-limiting examples may include operating system instructions, instructions that facilitate communicating with other devices, computers or servers, camera instructions that facilitate camera-related processes and functions, ML instructions for executing one or more models, visual recognition or vision system instructions, GUI instructions that facilitate GUI-related processes and functions, GNSS/navigation instructions to facilitate GNSS and navigation-related processes and functions, sensor instructions that facilitate sensor-related processes and functions, and media instructions to facilitate media-related processes and functions.

Processors 734 may be implemented in generally any suitable manner capable of executing the instructions to perform the operations and functions described in relation to the embodiments herein. Non-limiting examples may include one or more CPUs, VPUs, GPUs, microprocessors, multicore processors, coprocessors, CPLDs, ASIPs, microcontrollers, ICs, ASICs, FPGAS, PLAs, and/or accelerators. A person or ordinary skill will understand that processors 734 may be configured for a particular use or configured to execute instructions stored in volatile or non-volatile memory or otherwise accessible to processors 734 in order to perform the steps or operations according to embodiments of the present disclosure.

Implementation of at least some of the disclosed subject matter may lead to benefits including, but not limited to, more accurate, effective and timely law enforcement response to threat events. The more accurate, effective and timely law enforcement response may lead to less casualties and overall greater safety for people.

Alternatively, and/or additionally, implementation of at least some of the disclosed subject matter may lead to benefits including an increased awareness by people of current safety levels of an environment. Such increased awareness may also reduce casualties and provide greater safety for people.

As used in this application, “component,” “module,” “system”, “interface”, and/or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Unless specified otherwise, “first,” “second,” and/or the like are not intended to imply a temporal aspect, a spatial aspect, an ordering, etc. Rather, such terms are merely used as identifiers, names, etc. for features, elements, items, etc. For example, a first object and a second object generally correspond to object A and object B or two different or two identical objects or the same object.

Moreover, “example” and/or the like is used herein to mean serving as an example, instance, illustration, etc., and not necessarily as advantageous. As used herein, “or” is intended to mean an inclusive “or” rather than an exclusive “or”. In addition, “a” and “an” as used in this application are generally construed to mean “one or more” unless specified otherwise or clear from context to be directed to a singular form. Also, at least one of A and B and/or the like generally means A or B or both A and B. Furthermore, to the extent that “includes”, “having”, “has”, “with”, and/or variants thereof are used in either the detailed description or the claims, such terms are intended to be inclusive in a manner similar to the term “comprising”.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing at least some of the claims.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, many modifications may be made to this configuration without departing from the scope or spirit of the claimed subject matter.

Various operations of embodiments are provided herein. In some embodiments, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering will be appreciated by one skilled in the art having the benefit of this description. Further, it will be understood that not all operations are necessarily present in each embodiment provided herein. Also, it will be understood that not all operations are necessary in some embodiments.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above-described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure. In addition, while a particular feature of the disclosure may have been disclosed with respect to only one of several implementations, such feature may be combined with one or more other features of the other implementations as may be desired and advantageous for any given or particular application.

What is claimed is:

1. A method, comprising:
Providing a camera proximate a safety zone, wherein the camera is configured to detect a threat event in the safety zone;
Providing a computing device configured to generate a safety response based on threat event information;
Detecting, by the camera, a first threat event;
Generating, by the camera, a first set of threat event information based on the first threat event;
Receiving, by the computing device, the first set of threat event information;
Generating, by the computing device, a first safety response based on the first set of threat event information; and
Initiating the first safety response.

2. The method of claim 1 wherein the camera is configured to detect a threat event in the safety zone using a trained object detection model.

3. The method of claim 1, wherein the camera comprises a linked local device, and wherein the local device is configured to detect a threat event in the safety zone using a trained object detection model.

4. The method of claim 1, wherein the threat event comprises a person holding a brandished weapon.

5. The method of claim 4, wherein the brandished weapon is a gun, a knife, or a club.

6. The method of claim 1, wherein the first safety response comprises a safety alert.

7. The method of claim 1, wherein the first set of threat event information comprises an image depicting the first threat event, wherein the first safety response comprises a safety alert comprising the image, and wherein initiating the first safety response comprises sending the safety alert to a local law enforcement computing system or a local private security computing system.

8. The method of claim 1, wherein generating a first safety response further comprises prompting at least one insight model to provide an insight on the first set of threat event information, and wherein the first safety response comprises a safety alert comprising the insight.

9. A method, comprising:
Providing a camera proximate a safety zone, wherein the camera is configured to detect a threat event and a safety context factor in the safety zone;
Providing a computing device configured to generate a safety response based on threat event information and safety context factor information;
Detecting, by the camera, a first threat event and a first safety context factor;
Generating, by the camera, a first set of threat event information based on the first threat event and a first set of safety context factor information based on the first safety context factor;
Receiving, by the computing device, the first set of threat event information and the first set of safety context factor information;
Generating, by the computing device, a first safety response based on the first set of threat event information and the first set of safety context factor information; and
Initiating the first safety response.

10. The method of claim 9, wherein the camera is configured to detect a threat event and a safety context factor in the safety zone using a trained object detection model.

11. The method of claim 9, wherein the camera comprises a linked local device, and wherein the local device is configured to detect a threat event and a safety context factor in the safety zone using a trained object model.

12. The method of claim 9, wherein the threat event comprises a person holding a brandished weapon and the safety context factor comprises the number of people in the safety zone at the time of the threat event or concealed weapon indicators.

13. The method of claim 12, wherein the brandished weapon is a gun, a knife, or a club.

14. A method, comprising:
Providing a camera proximate a safety zone configured to detect a safety context factor in the safety zone;
Providing a computing device configured to generate a safety metric based on safety context factor update information;
Providing a client device configured to receive and display a safety metric;
Detecting, by the camera, a first safety context factor;
Generating, by the camera, a first set of safety context factor update information based on the first safety context factor;
Receiving, by the computing device, the first set of safety context factor update information;
Generating, by the computing device, a first safety metric;
Receiving, by the client device, the first safety metric; and
Displaying, by the client device, the first safety metric.

15. The method of claim 14, wherein the camera is configured to detect a safety context factor in the safety zone using a trained object detection model.

16. The method of claim 14, wherein the camera comprises a linked local device, and wherein the local device is configured to detect a safety context factor in the safety zone using a trained object model.

17. The method of claim 14, wherein the first safety metric comprises a current threat index for the safety zone, an estimate of the number of concealed weapons currently present in the safety zone, or an insight generated by an insight model.

18. The method of claim 14, wherein the first safety metric comprises a natural language insight generated by a large language model, wherein the client device is further configured to receive user input, and further comprising:
Receiving, by the client device, a first user input requesting additional insight;
Receiving, by the computing device, the first user input requesting additional insight;
Generating, by the computing device, a second safety metric comprising a second natural language insight generated by the large language model, wherein the generating comprises prompting the large language model with the first user input;
Receiving, by the client device, the second safety metric; and
Displaying, by the client device, the second safety metric.

19. The method of claim 14, further comprising:
Detecting, by the camera, a second safety context factor;
Generating, by the camera, a second set of safety context factor update information based on the second safety context factor;
Receiving, by the computing device, the second set of safety context factor update information;
Generating, by the computing device, a second safety metric;
Receiving, by the client device, the second safety metric; and
Displaying, by the client device, the second safety metric.

20. The method of claim 19, wherein the second safety metric comprises a current threat index for the safety zone, an estimate of the number of concealed weapons currently present in the safety zone, or a natural language insight generated by a large language model.
